(19) United States
(12) Patent Application Publication
(10) Pub. No.: US 2011/0061157 A1
(43) Pub. Date: Mar. 17, 2011

(54) Potty, in particular for infants

(76) Inventor: Peter Goergen, Wadern-Nunkirchen (DE)

(21) Appl. No.: 12/806,728

(22) Filed: Aug. 19, 2010

(30) Foreign Application Priority Data
Aug. 19, 2009 (DE) 10 2009 037 925.8

(51) Int. Cl. A47K 11/04; B29C 45/12

(52) U.S. Cl. 4/483; 264/328.1

(57) ABSTRACT

The invention relates to a potty, in particular for infants, that is produced from plastics material by injection moulding, comprising a lower part (12), which has a contact face (14) for providing support on a base, comprising a side wall (15) supported at the contact face (14) and comprising an edge (17) arranged at the upper end of the side wall (15) as well as an inner receptacle region (22), and comprising an upper part (26), which is separate from the lower part (12) and comprises a seat (27) having a pot-shaped shell part (30) arranged inside the seat (27), comprising a supporting edge (28) that is associated with the outer face of the seat (27), carries the seat (27) and is supported at the edge (17) of the lower part (12), the shell part (30) projecting into the receptacle region (22) of the lower part (12), at least in part, the side wall (15) of the lower part (12) comprising a decorative surface produced by an in-mould process, the edge (17) provided at the lower part (12) being configured as a peripheral rim (21) extending along the side wall (15), and the supporting edge (28) of the upper part (26) being arranged, at least over portions, on the peripheral rim (21) and overlapping this, at least over portions.

The invention relates to a potty, in particular for infants, in accordance with the preamble of claim 1.

Potties are preferably used when travelling or in order to help infants become toilet trained. For example a two-piece potty is known from the company Baby Björn AG, which is produced from plastics material by injection moulding. This potty comprises a lower part, which has a contact face for providing support on a base. A side wall is supported at this contact face and transitions at an upper end into an edge and an inner receptacle region. An upper part, which is separate from the lower part and can be removed from the lower part for emptying and cleaning, comprises a seat and a pot-shaped shell part arranged inside the seat. The seat preferably transitions integrally into the shell part. A supporting edge is provided at an outer face of the seat, carries the seat and is supported at the edge of the lower part. The pot-shaped shell part thus engages with the receptacle region of the lower part.

Potties of this type are preferably configured in two colours so as to look attractive. A colour for pigmenting the plastics material is thus selected for each of the lower part and the upper part. These configurations no longer satisfy the ever-increasing demands placed on design.

Furthermore, in two-piece potties of this type the upper part may often shift relative to the lower part.

The object of the invention is therefore to propose a potty that has an attractive external design and at the same time is highly secure for daily use.

This object is achieved by a potty having the features of claim 1. Further advantageous configurations and developments are disclosed in the further claims.

The configuration of a potty according to the invention in which the side wall of the lower part comprises a decorative surface produced by an in-mould process makes it possible to create, in a simple manner different surfaces (depending on the desired design or on requirements), which are independent of the further coloured configuration of the upper and lower parts. In order to produce a decorative surface of this type at a side wall, it is necessary for the edge provided at the lower part to be configured as a peripheral rim extending along the side wall so as to achieve a high level of quality of the decorative surface at the outer wall. This peripheral rim may be formed in a simple manner by the two-piece configuration of the potty. At the same time a secure arrangement of the upper part relative to the lower part is made possible, the supporting edge of the upper part being arranged, at least over portions, on the peripheral rim of the lower part and overlapping this, at least over portions. The upper part can thus be securely fixed and positioned relative to the lower part. At the same time a good transfer of load over the seat and away onto the contact face is obtained via the interfaces between the upper and lower parts. This configuration of the two-piece potty according to the invention thus makes it possible to equally achieve the advantages of high design standards and flexible adaptation to different designs requirements, as well as high operational reliability.

A preferred embodiment of the potty provides for the upper part to comprise a splashguard portion in a front region and, opposite, a supporting portion in the rear region, the splashguard portion and the supporting portion being taller than the seat and preferably transitioning flowingly into the seat. The splashguard portion is preferably shorter than the supporting portion. This type of saddle-shaped configuration of the upper part is achieved by a good fit between the seat and the supporting face and, at the same time, the splashguard portion prevents any urine from leaking outside in an undesired manner.

Furthermore, it is preferred for a flattened region to be provided on a rear face of the supporting face on the upper part, which flattened region comprises an engagement opening. This makes it possible to hold the upper part in a region that is not normally wetted by urine. In addition, the outer contour (closed incidentally) of the upper part can be grasped in a simple manner so as to empty and clean the upper part.

A further preferred configuration of the invention provides a locking member at the edge of the lower part, preferably in a front region of the lower part, at which locking member a receiving member engages with the supporting edge of the upper part and prevents the upper part from being removed from the lower part. A locking clip is preferably provided at the upper part, opposite the receiving member, and engages removably with the lower part. This arrangement makes it possible to securely fix the upper part to the lower part for use. Furthermore, it is thus made possible for the upper part and the lower part to be connected and separated in a simple manner. For example, in order to complete the potty it may be provided for the receiving member of the upper part to first engage with the locking member of the lower part. A rear region of the upper part is moved towards the lower part by a pivoting movement about this semi-formed hinge joint. Once the supporting portion of the upper part is arranged, at least over portions, on the peripheral rim and overlaps this, at least over portions, the locking clip for engaging the lower part can be attached in such a way that the upper part is prevented from being removed from the lower part.

The locking clip arranged on the upper part and arranged in a rear region preferably engages with a recess in the lower part, which recess is provided in the flattened region of the lower part. It is therefore possible for the locking clip to be clipped or clicked-in in a simple manner and to be released in an easily accessible manner.

In accordance with a preferred embodiment the locking strip is arranged on the upper part, in particular on a flattened region of the upper part, by an integral hinge. The potty may therefore consist merely of the upper and lower parts, without the need for additional, separate parts, and a secure connection between the upper and lower parts can thus be achieved.

The receptacle region arranged in the lower part of the potty is preferably arranged in a recessed manner relative to an end face of the peripheral rim, said receptacle region preferably being formed by a web portion that is oriented at right angles to the side wall or at an angle deviating therefrom by less than ±20° so as to be oriented at right angles to the outer wall. This arrangement poses the advantage that the polymer melt impacts the side wall almost or virtually at right angles as it flows over the side wall and spreads out in both directions, this clearance being immediately filled with plastics material owing to the dimensioning of the peripheral rim, in such a way that the only direction of flow of the polymer melt is along the outer wall toward the contact face. A decorative film provided on the outer wall and preferably held in the injection mould by electrostatic charge is therefore smoothly coated and fixed, almost automatically. A retaining portion for the decorative film is thus formed by the quick filling of the region for forming the peripheral rim, which portion also prevents the decorative film from being displaced or creased inside the injection mould.

It is further preferably provided for the receptacle region to extend completely along the peripheral rim and to comprise at least a strip-shaped portion. The polymer melt therefore flows toward the side wall in a right-angled or virtually right-angled manner in the entire region along the side rim so as to achieve a high level of quality of the decorative surface on the side wall.

The receptacle region of the lower part preferably comprises a through-opening for receiving the shell part at the upper part. This through-opening makes it possible to provide a shell part having a large volume.

The receptacle region of the lower part also comprises a hump-shaped elevation beside the flattened region. This hump-shaped elevation substantially corresponds to the contour of the supporting portion, which transitions into the seat at the upper part. The potties can therefore be stacked on top of one another, it being possible for a high supporting portion to be formed that is not restricted by the distance between the receptacle region and the contact face at the lower part when the potties are stacked inside one another.

Similarly, a hump-shaped elevation is preferably also provided in the front region of the receptacle region. The splashguard portion may therefore also be formed with the necessary height.

A further preferred configuration of the potty provides for the shell part to comprise a base in the upper part, which base lies in the plane of the contact face of the lower part when the upper part is fixed to the lower part, or for the base to be at least slightly taller than the contact face. In the first variant, load is also transferred or support is also provided at the base via the shell part. In the second alternative no force is transferred from the shell part to the base. This shell part can thus be formed with a smaller wall thickness.

In accordance with a further advantageous configuration of the invention the supporting edge of the upper part comprises a continuously peripheral shoulder that extends via its respective ends into the flattened region, at least in part. A particularly high level of rigidity of the upper part is therefore obtained since the shoulder also extends over a corner region between the supporting edge and the flattened region.

The receptacle region of the lower part is preferably also completely surrounded by the peripheral rim. A particularly rigid configuration of the lower part is created by this arrangement. At the same time, a completely peripheral shoulder may support the supporting edge of the upper part.

A further preferred configuration of the invention provides for the side wall of the lower part and the flattened region of the lower part to be aligned with the supporting edge of the upper part and the flattened region of the upper part. A good level of load transfer can therefore be created. Furthermore, an aesthetically pleasing shape is obtained in such a way that the two-piece potty looks like a mould.

The invention and further advantageous embodiments and developments thereof will be described and explained in greater detail hereinafter with reference to the examples shown in the drawings. The features to be inferred from the description and the drawings may be applied, in accordance with the invention, either individually or in any combination.

In the drawings:

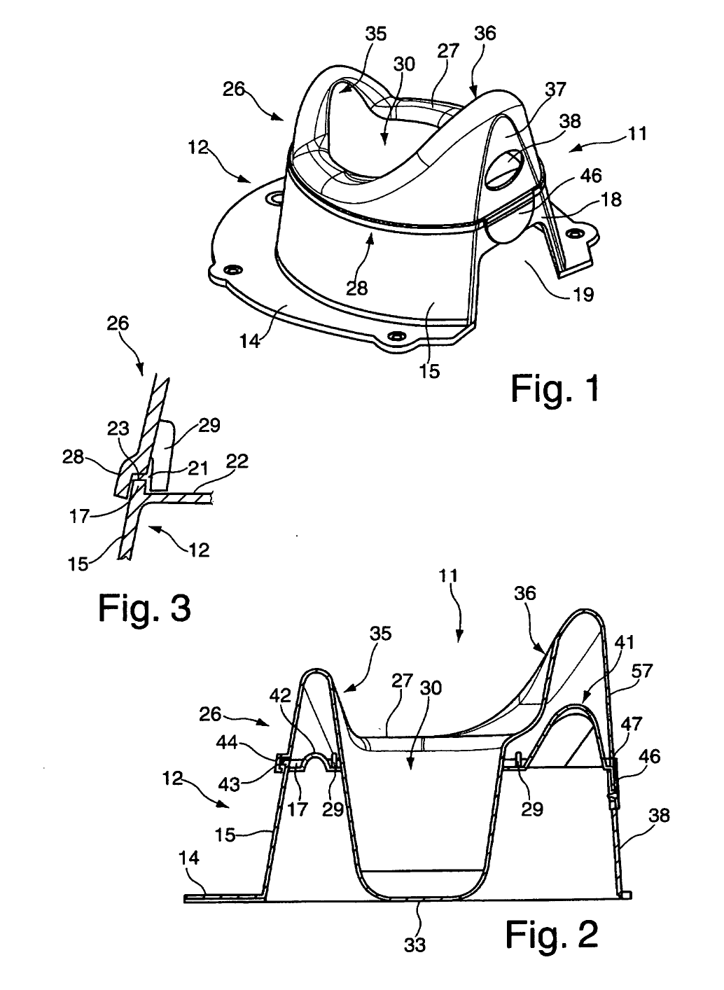

FIG. 1 is a perspective plan view of a two-piece potty,

FIG. 2 is a full, schematic cross-sectional view of the potty according to FIG. 1,

FIG. 3 is a schematically enlarged cross-sectional view of the edge region of the upper part and lower part of the potty,

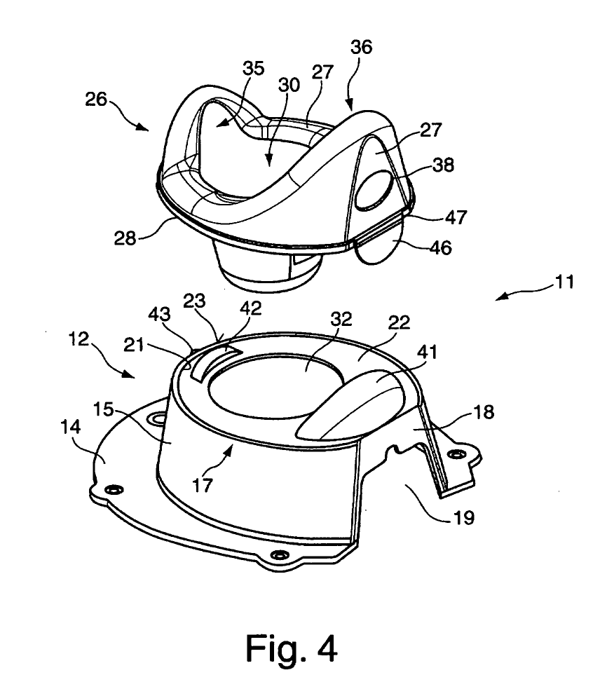

FIG. 4 is a schematic view of the potty according to FIG. 1 comprising a completely raised upper part,

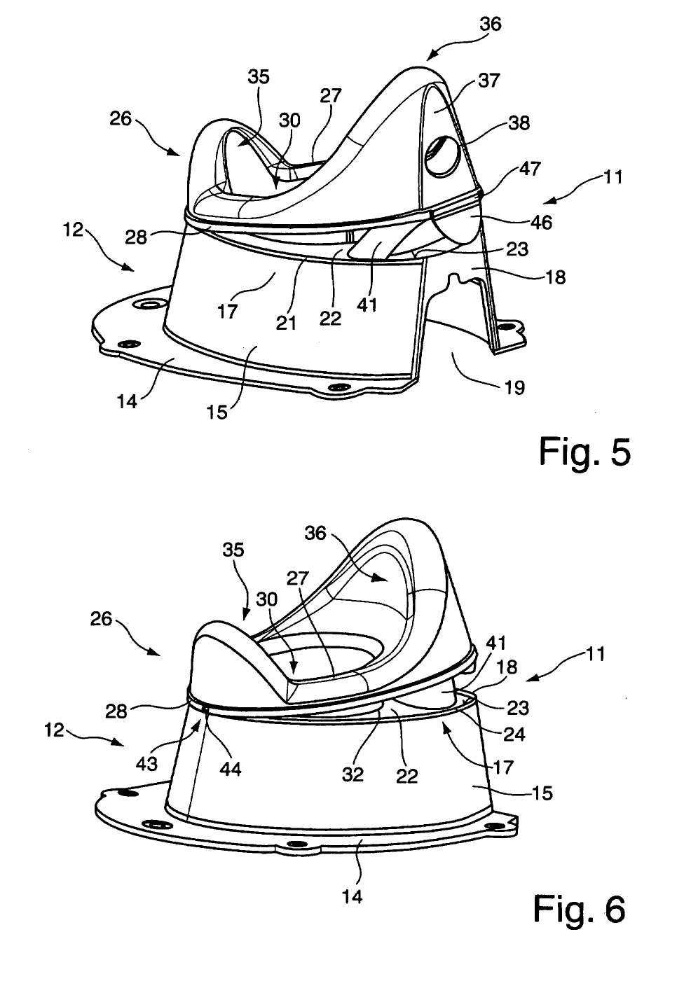

FIG. 5 is a perspective view of a potty comprising an upper part in an intermediate position relative to a lower part, and

FIG. 6 is a further schematic view of the intermediate position of the upper part relative to the lower part according to FIG. 5.

FIG. 1 illustrates a schematic view of the potty 11 according to the invention. In order to describe the potty 11 according to FIG. 1 in greater detail, reference is made to FIG. 2, which shows the potty according to FIG. 1 in full cross-section, and reference is also made to FIG. 4, which shows a two-piece potty 11 made of plastics material and produced by injection moulding.

The potty 11 comprises a lower part 12 having a contact face 14, at which stopper members oriented downwardly and not shown in greater detail may be provided as an anti-slip means relative to the support. For example the contact face 14 is configured as a brim. Alternatively, only one narrow, web-shaped face having enlarged sectors for receiving the stopper members may also be provided. A side wall 15 connects to the contact face 14, which side wall extends as far as an upper edge 17. A lower part having an oval contour is formed by the side wall 15 and comprises a slightly conically extending side wall 15. This oval shape is only exemplary. The peripheral side wall 15 of the lower part 12 is interrupted by a flattened region 18, which is preferably arranged in a rear region of the potty 11. A recess 19 is provided in this flattened region 18 and extends as far as the vicinity of the edge 17.

The lower part 12 is produced from plastics material in an injection moulding process. In this instance it is preferably provided for the side wall 15 of the lower part 12 to comprise a decorative surface produced by the in-mould process. In this process the desired decorative film is preferably placed in the mould before the polymer melt is injected into the mould, which decorative film is preferably held in the mould by an electrostatic charge. In order to achieve a high level of quality of the decorative surface, the edge 17 is configured as a peripheral rim 21, a receptacle region 22 of the lower part 12 that forms a type of end face for the lower part 12 and is configured as a wall portion being arranged in a recessed manner relative to an end face 23 of the rim 21. At the same time, this wall portion of the receptacle region 22 is oriented at right angles to the side wall 15 or at an angle thereto of less than ±20°. The polymer melt can therefore impact the side wall 15 almost frontally during the injection moulding process and holds the decorative film fixed to the mould. The clearance formed by the rim 21 is then quickly filled with polymer melt in such a way that the flowing polymer melt then flows off along the side wall 15 toward the contact face 14. The decorative film is therefore smoothed simultaneously. The receptacle region 22 or a wall portion connected directly to the rim 21 preferably extends completely peripherally and at least in a strip-shaped manner along the peripheral face of the side wall 15, on which a decorative surface is formed by a decorative film.

An upper part 26 of the potty 11 can be placed on the lower part 12 and connected thereto in a rigid, yet removable manner. The upper part 26 comprises a seat 27, the outer face of which transitions into a supporting edge 28. As shown in the enlarged sectional view in FIG. 3, this supporting edge 28 of the upper part 26 lies, at least in part, on the end face 23 of the peripheral rim 21 and overlaps this rim 21, at least in part. It is preferably provided for the supporting edge 28 to completely overlap the peripheral rim 21, at least in the region of the side wall 15, and to be arranged on the end face 23. It is therefore possible to create a stable and rigid two-piece embodiment of the potty 11. At the same time, the risk of being injured at the rim 21 is reduced by the complete overlapping. In addition, supporting ribs 29 may be provided at an inner wall portion of the upper part 26 and arranged at a distance from the supporting edge 28 so the edge 17 of the lower part can engage in between when the upper part 26 is arranged on top. The supporting ribs 29 are preferably also supported on the receptacle region 22. The upper part 26 can thus be better fixed to the lower part 12.

A pot-shaped shell part 30 is adjacently moulded onto an inner face of the supporting face 27, which shell part extends through a recess 32 in the receptacle region 22. A base 33 of the shell part 30 preferably lies in the plane of the contact face 14. In a front region of the upper part 26 the seat 27 transitions into a splashguard portion 35, which is taller than the seat 27. In the rear region of the upper part 12 the seat 27 transitions into a supporting portion 36 so as to offer the infant secure support on the potty 11. The supporting portion 36 is preferably taller than the splashguard portion 35. At a rear face of the supporting portion 36 a flattened region 37 is provided, which transitions directly into the flattened region 18 of the lower part. An engagement opening 38 is provided in the flattened region 37 in such a way that it is possible to handle the upper part 26 in a simple manner.

A hump-shaped elevation 41 is provided at the lower part 12 in the rear region of the receptacle region 22 in the vicinity of the flattened region 18 and extends towards the upper part 12 and enters inside a supporting portion 36, at least in part. This makes it possible for a plurality of potties 11 to be stacked on top of one another in a space-saving manner since the supporting portion 36 of the lower potty 11 engages with the elevation 41 of the potty 11 arranged above. At the same time, the shell parts 30 of the potties 11 arranged on top of one another may engage with one another. Similarly, an elevation 42 may also preferably be provided in a front region so the splashguard portion 35 can engage with an elevation 42 of this type when the potties 11 are stacked on top of one another.

A locking member 43 is preferably moulded onto the front region of the lower part 12 for locking the upper part 26 relative to the lower part 12 and engages with a receiving member 44 moulded onto the upper part 26. The locking member 43 and the receiving member 44 may also each be produced as a separate component and may be fixed to the upper part 26 or to the lower part 12, for example by a clipping or locking connection. This receiving member 44 is almost formed as an undercut so as to engage with the locking member 43, in such a way that the upper part 26 is held down relative to the lower part 12 and can still be swivelled in a first phase. A position of this type emerges, for example, from FIGS. 5 and 6. In these illustrations an intermediate step is shown during the fixing or removing of the upper part 26 to/from the lower part 12. In any case the receiving member 44 of the upper part 36 engages with the locking member 43 of the lower part 12 in such a way that the upper part 26 is fixed to the lower part 12 in the position shown in FIGS. 5 and 6. The upper part 26 can then be swivelled on the lower part 12. A locking clip 46 is actuated so as to provide complete fixing, in such a way that it engages with the recess 19 in the flattened region 18. The locking clip 46 therefore comprises a locking or clipping member (not shown in greater detail) so as to provide a releasable fixing. An integral hinge 47 is formed at the flattened region 37 for hinged connection to the locking clip 46. Alternatively, further fixing mechanisms or locks may be provided. The locking member 43 and the receiving member 44 may also be arranged interchangeably at the lower part 12 and upper part 26. The locking member 43 may also be configured as a locking projection or as a catch, which engages with a complementary geometry of the upper part 26 and therefore fixes the upper part 26 to the lower part 12.

### LIST OF REFERENCE NUMERALS

11. Potty
12. Lower part
14. Contact face
15. Side wall
17. Edge
18. Flattened region
19. Recess
21. Rime
22. Receptacle region
23. End face
26. Upper part
27. Seat
28. Supporting edge
30. Shell part
32. Through-opening in 22
33. Base of 30
35. Splashguard portion
36. Supporting portion
37. Flattened region at 26
38. Engagement opening
41. Elevation
42. Elevation
43. Locking member
44. Receiving member
46. Locking clip
47. Integral hinge

1. Potty, in particular for infants, that is produced from plastics material by injection moulding,
comprising a lower part, which has a contact face for providing support on a base, comprising a side wall supported at the contact face and comprising an edge arranged at the upper end of the side wall as well as an inner receptacle region, and
comprising an upper part, which is separate from the lower part and comprises a seat having a pot-shaped shell part arranged inside the seat, comprising a supporting edge that is associated with the outer face of the seat, carries the seat and is supported at the edge of the lower part, the shell part projecting into the receptacle region of the lower part, at least in part,
wherein
the side wall of the lower part comprises a decorative surface produced by an in-mould process,
the edge provided at the lower part is configured as a peripheral rim extending along the side wall, and
in that the supporting edge of the upper part is arranged, at least over portions, on the peripheral rim and overlaps this, at least over portions.

2. Potty according to claim 1, wherein the upper part comprises a splashguard portion in the front region and a supporting portion opposite, which are taller than the seat and preferably transition flowingly into the seat.

3. Potty according to claim 1, wherein a flattened region is provided on a rear face of the supporting portion on the upper part, which flattened region comprises an engagement opening.

4. Potty according to claim 1, wherein a locking member is provided at the edge of the lower part, at which locking member a receiving member engages with the supporting edge of the upper part and prevents the upper part from being removed from the lower part, and in that a locking clip is preferably provided opposite the receiving member on the upper part and engages removably with the lower part.

5. Potty according to claim 4, wherein the locking clip engages with a recess in a flattened region of the lower part.

6. Potty according to claim 4, wherein the locking clip is arranged on the upper part, in particular on a flattened region of the upper part, by an integral hinge.

7. Potty according to claim 1, wherein the receptacle region of the lower part is arranged in a recessed manner relative to an end face of the peripheral rim, said receptacle region preferably being formed by a web portion that is oriented at right angles to the side wall or at an angle deviating there from by less than ±20° so as to be oriented at right angles to the outer wall.

8. Potty according to claim 1, wherein the receptacle region extends along the peripheral rim and comprises at least a strip-shaped portion.

9. Potty according to claim 1, wherein a through-opening is provided in the receptacle region for receiving the shell part of the upper part.

10. Potty according to claim 1, wherein a hump-shaped elevation is moulded onto the receptacle region in the vicinity of the flattened region.

11. Potty according to claim 1, wherein a hump-shaped elevation is provided in the front region of the receptacle region, preferably opposite the locking member.

12. Potty according to claim 1, wherein the shell part comprises a base in the upper part, which base lies in the plane of the contact face of the lower part or is at least slightly taller than this.

13. Potty according to claim 1, wherein the supporting edge is formed by a continuously peripheral shoulder that extends via its respective ends into the flattened region, at least in part.

14. Potty according to claim 1, wherein the receptacle region of the lower part is surrounded completely by the peripheral rim.

15. Potty according to claim 1, wherein the side wall of the lower part and the flattened region of the lower part are aligned with the supporting edge of the upper part and the flattened region of the upper part.
